(19) United States
(12) Patent Application Publication
(10) Pub. No.: US 2025/0275530 A1
(43) Pub. Date: Sep. 4, 2025

(54) CLIMBING STAND SYSTEM

(71) Applicant: BROADSIDE STANDS, LLC, Pottstown, PA (US)

(72) Inventor: Garrett CLARK, Pottstown, PA (US)

(73) Assignee: BROADSIDE STANDS, LLC, Pottstown, PA (US)

(21) Appl. No.: 19/048,570

(22) Filed: Feb. 7, 2025

Related U.S. Application Data
(60) Provisional application No. 63/551,984, filed on Feb. 9, 2024.
(60) Provisional application No. 63/561,199, filed on Mar. 4, 2024.

(51) Int. Cl. A01M 31/02; A63B 27/00

(52) U.S. Cl. CPC A01M 31/02; A63B 27/00

(57) ABSTRACT

A climbing stand system for climbing a tree is disclosed. The climbing stand system includes a climbing stand assembly and a tree cord. The climbing stand assembly includes a base plate, a pivotable center post, removable arm guards, and integrally-formed tie-down anchors. When climbing, the tree cord is configured to be attached to the tie-down anchors and guided through the arm guards around the tree. The tree cord includes a metallic core, a sheath, and shrink-wrapped knotted end regions. The climbing stand assembly is transformable between a climbing platform having the center post in an extended position and the arm guards connected to the base plate and a saddle platform having the center post in the extended position and the arm guards partially or fully removed from the base plate.

### TECHNICAL FIELD

This application is a Non-Provisional Application which claims the benefit of U.S. Provisional Patent Application No. 63/561,984, filed Feb. 9, 2024, and U.S. Provisional Patent Application No. 63/561,199, filed Mar. 4, 2024, each of which is incorporated herein by reference in its entirety.

### TECHNICAL FIELD

The present disclosure relates to elevated platforms and, more particularly, to tree climbing systems for use in hunting and other suitable environments.

### BACKGROUND

Tree stands are devices used by hunters to elevate themselves above ground level while hunting game animals. These stands provide hunters with improvements in visibility, concealment, and safety while hunting from elevated positions in trees. Safety is paramount when attaching and using tree stands, as falling from an elevated position can lead to severe injuries.

Modern tree stands typically consist of a platform, a seat, and a means of attachment to a tree, such as a conventional rope or strap directed through square metal tubing to guide the rope at the proper angle relative to the tree. However, these conventional tree stands have an extensive equipment profile and substantial weight, making them difficult for hunters to manage and carry and increasing the amount of time and effort required to climb up and down a tree. For instance, conventional tree stands typically require the use of tree sticks or two-piece climbing platforms that do not allow them to be used as stand-alone saddle platforms because their support arms are fixedly attached and cannot be removed once the user reaches the desired height up the tree. Additionally, conventional tree stands are prone to being kicked out from under the hunter, causing the stand to fall to the ground while the hunter remains stranded in the tree.

### SUMMARY

Aspects of this disclosure relate to improved climbing stand systems having improved climbing stand assemblies and improved tree cords. The improved climbing stand assemblies disclosed herein include a base plate with integral tie-down anchors, a pivotable center post having a top cleat, and arm guards that may be removed at the desired climbing height to transform the climbing stand assembly from a climbing platform into a saddle platform. Additionally, the improved tree cords disclosed herein include a metallic core, a sheath surrounding the metallic core, and shrink-wrapped knotted ends, the combination of which allows the tree cord to conform to the shape and angle of the tree while providing suitable strength and rigidity to support the climbing stand assembly, its user, and any additional loads.

In accordance with one aspect of the disclosure, a climbing stand assembly is disclosed. The climbing stand assembly includes a base plate comprising a center connection portion, a first lateral connection portion disposed on a first side of the of the base plate, and a second lateral connection portion disposed on a second side of the base plate opposite the first side of the base plate. The climbing stand assembly further includes a center post configured to be pivot-ably connected to the center connection portion of the base plate. The center post is pivotable between a retracted position that is substantially parallel to a longitudinal axis of the base plate and an extended position that is non-parallel to the longitudinal axis of the base plate. The climbing stand assembly further includes a first arm guard configured to be removably connect-ed to the first lateral connection portion of the base plate. The climbing stand assembly further includes a second arm guard configured to be removably connected to the second lateral connection portion of the base plate.

In accordance with another aspect of the disclosure, a climbing stand system is dis-closed. The climbing stand system includes a climbing stand assembly comprising a base plate, a center post configured to be pivotably connected to a center connection portion of the base plate, a first arm guard configured to be removably connected to a first lateral connection portion of the base plate, a second arm guard configured to be removably connected to a second lateral connection portion of the base plate, and at least two tie-down anchors formed integrally with the base plate. The climbing stand system includes a tree cord configured to be removably connected to the at least two tie-down anchors, the first arm guard, and the second arm guard. The tree cord includes a metallic core, a sheath surrounding the metallic core, and shrink-wrapped knotted end regions.

In accordance with another aspect of the disclosure, a method for manufacturing a climbing stand assembly is disclosed. The method includes forming a base plate comprising a center connection portion, a first lateral connection portion disposed on a first side of the of the base plate, a second lateral connection portion disposed on a second side of the base plate opposite the first side of the base plate, at least two tie-down anchors, and at least two boot strap hole portions. The method further includes forming a center post configured to be pivotably connect-ed to the center connection portion of the base plate. The method further includes forming a first arm guard configured to be removably connected to the first lateral connection portion of the base plate. The method further includes forming a second arm guard configured to be re-movably connected to the second lateral connection portion of the base plate.

### BRIEF DESCRIPTION OF THE DRAWINGS

The example embodiments disclosed herein may be better understood with reference to the following description and the appended drawings, wherein like elements are numbered alike.

FIG. 1 is a perspective view of an example climbing stand assembly according to aspects of the disclosure;

FIG. 2 is a close-up perspective view of an example tie-down anchor according to aspects of the disclosure;

FIGS. 3A and 3B are perspective and cut-away views of an example tree cord according to aspects of the disclosure;

FIG. 4 is a top view of an example climbing stand system according to aspects of the disclosure;

FIG. 5 is a side view of the example climbing stand system of FIG. 4 according to aspects of the disclosure;

FIG. 6 is a perspective view of the example climbing stand system of FIG. 4 according to aspects of the disclosure; and

FIG. 7 is a flow chart of an example method for manufacturing a climbing stand assembly according to aspects of the disclosure.

### DETAILED DESCRIPTION

The present disclosure sets forth various aspects of improved climbing stand assembly and tree cord constructions. The climbing stand assemblies and systems disclosed herein can be used by hunters, nature enthusiasts, lineworkers, or other users. For example, lineworkers can utilize the climbing stand assemblies and systems disclosed herein to climb wooden utility poles to install and repair electrical power lines and telecommunications cables.

As described in greater detail below, there are many advantages to the climbing stand assembly and tree cord constructions disclosed herein. For example, the climbing stand assemblies disclosed herein include removable arm guards, allows users to remove the arm guards at the desired climbing height to transform the climbing stand assembly from a climbing platform into a saddle platform. This arrangement provides users with the freedom to move around the climbing stand assembly, use it as a saddle platform, or use it as a climbing saddle platform, depending on their needs. In contrast, conventional tree stands include fixed arms that must remain attached. In another example, the climbing stand systems disclosed herein provide a substantially reduced equipment profile and weight, making them easier for users to manage and carry and substantially decreasing the amount of time and effort required to climb up and down a tree, utility pole, or other structure. In yet another example, the climbing stand systems disclosed herein securely hold the climbing stand assembly to the tree, utility pole, or other structure at the proper angle, providing stability and safety for the user. In still another example, the climbing stand systems disclosed herein are less prone to being kicked out from under the hunter, reducing the risk of the climbing stand assembly falling to the ground while the user remains stranded in the tree, utility pole, or other structure. Further still, unlike conventional tree stands, the climbing stand systems disclosed herein do not require the use of tree sticks or two-piece climbing platforms with fixed arms and instead utilize removable arm guards that allow them to be used as stand-alone saddle platforms by partially or fully removing the arms once at the desired height up the tree, utility pole, or other structure.

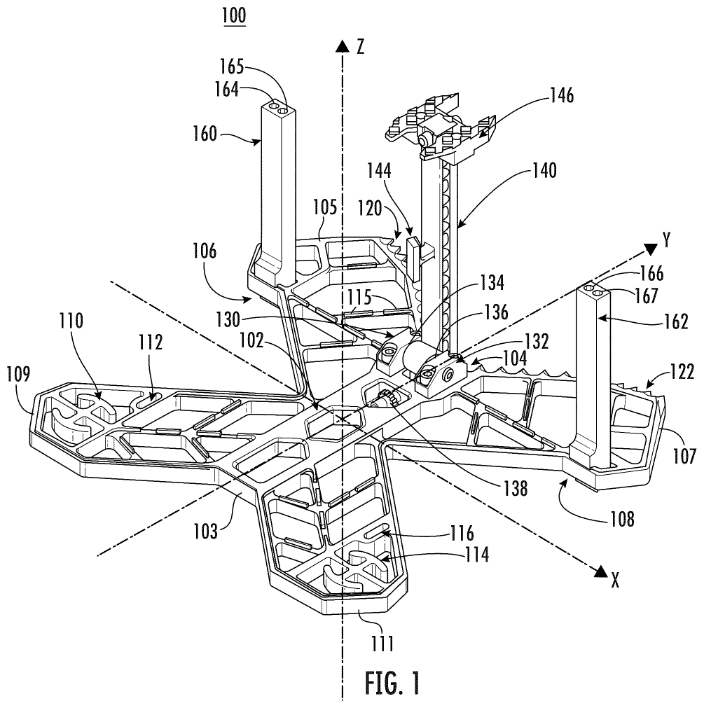

FIG. 1 is a perspective view of an example climbing stand assembly 100 according to aspects of the disclosure. As shown, the climbing stand assembly 100 includes a base plate 102, a center post 140, a first arm guard 160, and a second arm guard 162. For purposes of clarification, and not of limitation, FIG. 1 includes a relative Cartesian coordinate system having a lateral axis X, a longitudinal axis Y, and a vertical axis Z. As shown, increasing x values indicate a rightward direction (e.g., towards a right side of the climbing stand assembly 100), and decreasing x values indicate a leftward direction (e.g., towards a left side of the climbing stand assembly 100). As shown, increasing y values indicate a forward direction (e.g., towards a front side of the climbing stand assembly 100, towards the tree), and decreasing y values indicate a rearward direction (e.g., towards a rear side of the climbing stand assembly 100, away from the tree). As shown, increasing z values indicate an upward direction (e.g., towards a top side of the climbing stand assembly 100, towards the top of the tree), and decreasing z values indicate a downward direction (e.g., towards a bottom side of the climbing stand assembly 100, towards the ground).

In some aspects, the base plate 102 is configured to provide a standing surface for a user (e.g., a hunter or other tree climber) that allows the user to pivot safely and ergonomically around the climbing stand assembly 100 to attain a desired standing position. As shown, the base plate 102 includes a frame forming a number of cells arranged in an “X” shape. As shown, the base plate 102 has a center portion 103, a first wing portion 105, a second wing portion 107, a third wing portion 109, and a fourth wing portion 111. As shown, the base plate 102 further includes a plurality of studs 115 configured to function as boot grips for improved user safety and stability. In some aspects, the base plate 102 may be formed of a metal material (e.g., billet, milled, or cast aluminum), metal alloy material (e.g., billet, milled, or cast aluminum alloy), composite material (e.g., continuous, forged, or milled carbon fiber), any other suitable material, or a combination thereof, and may include an optional cladding layer (e.g., rubber, powder coating, paint, etc.). For example, the base plate 102 may be milled (e.g., by a three-axis computer numerical control (CNC) machine) from a 16 inch by 18 inch by 0.75 inch plate of 7075-T6 aluminum.

As shown, the center portion 103 includes a center connection portion 104 disposed proximate a longitudinal axis Y of the base plate 102 and forward of a lateral axis X of the base plate 102 (e.g., toward the front of the base plate 102). As shown, the center post 140 is pivotably connected to the center connection portion 104 of the base plate 102. In some aspects, the center post 140 is pivotable between a retracted position that is substantially parallel to the longitudinal axis and an extended position (as shown in FIG. 1) that is non-parallel to the longitudinal axis.

In some aspects, the center connection portion 104 of the base plate 102 may include at least one pivot block attached to the base plate 102, wherein the center post 140 is pivotably connected to the at least one pivot block. For example, as shown, the center connection portion 104 of the base plate 102 includes a first pivot block 130 attached to a left-side portion of the center portion 103 of the base plate 102 by one or more fastening mechanisms, such as, as shown, two pairs of vertically-oriented socket head bolts (e.g., grade 8, 5/16 inch) and nuts (e.g., nylon- or polymer-insert lock nuts) with the base plate 102 having a cut-out portion configured to accommodate each nut to substantially prevent the nut from spinning as the socket head bolt is threaded into or out of the nut, thereby eliminating the need for using a wrench during assembly or disassembly. As shown, the center connection portion 104 of the base plate 102 further includes a second pivot block 132 attached to a right-side portion of the center portion 103 of the base plate 102 by one or more fastening mechanisms, such as, as shown, two pairs of vertically-oriented socket head bolts (e.g., grade 8, 5/16 inch) and nuts (e.g., nylon- or polymer-insert lock nuts) with the base plate 102 having a cut-out portion configured to accommodate each nut to substantially prevent the nut from spinning as the socket head bolt is threaded into or out of the nut, thereby eliminating the need for using a wrench during assembly or disassembly.

As shown, the center post 140 is disposed laterally between the first pivot block 130 and the second pivot block 132, a first shoulder washer 134 is disposed between the left side of the center post and the right side of the first pivot block 130, a second shoulder washer 136 is disposed between the right side of the center post and the left side of the second pivot block 132, and a laterally-oriented shoulder socket head bolt (e.g., grade 9, 5/16 inch) passes through each of these components and is secured by a shoulder nut (e.g., a nylon- or polymer-insert lock nut), allowing the center post 140 to pivot upward toward the tree (as shown in FIG. 1) or downward toward the base plate 102. In some aspects, each of the first shoulder washer 134 and the second shoulder washer 136 may be formed of a polycarbonate, nylon, or plastic material and configured to substantially prevent the climbing stand assembly 100 from producing noise (e.g., squeaking) as the center post 140 pivots upward and downward as well as to increase friction between the center post 140 and the first and second pivot blocks 130, 132 to provide for a tensioned pivot. As shown, each of the first pivot block 130 and the second pivot block 132 has a cut-out portion to substantially prevent the shoulder nut from rotating as the shoulder socket head bolt is threaded into or out of the shoulder nut, providing for ambidextrous fastening of the shoulder bolt from right-to-left or left-to-right and eliminating the need to use a wrench during assembly or disassembly. As shown, each of the first pivot block 130 and the second pivot block 132 may be trapezoid in shape and have two vertically-oriented holes passing therethrough to accommodate the vertically-oriented socket head bolts and a laterally-oriented hole passing therethrough to accommodate the laterally-oriented shoulder socket head bolt. As shown, the first pivot block 130 and the second pivot block 132 raise the pivot point of the center post 140 above the top surface of the base plate 102, providing a substantial reduction in leverage against itself.

In some aspects, the center post 140 may be formed of a metal material (e.g., billet, milled, or cast aluminum), metal alloy material (e.g., billet, milled, or cast aluminum alloy), composite material (e.g., continuous, forged, or milled carbon fiber), any other suitable material, or a combination thereof, and may include an optional cladding layer (e.g., rubber, powder coating, paint, etc.). For example, the center post 140 may be milled (e.g., by a three-axis CNC machine) from an aluminum or carbon fiber material. As shown, the center post 140 may include a plurality of holes (e.g., 0.257 inch diameter) drilled (e.g., by a three-axis CNC machine) laterally through the center post 140. As shown, the center post 140 includes an integrally-formed versa button 144, allowing the user to attach a rope, strap, or other attachment mechanism around the center post 140 and the tree to mount the center post 140 to the tree once the user reaches the desired height up the tree (e.g., hunting height). As shown, the edges of the versa button 144 are chamfered and/or rounded to substantially prevent the risk of cutting, fraying, or chaffing any ropes, cords, or straps attached to the versa button 144. As shown, the center post 140 includes a top cleat 146 that is attached to a top portion of the center post 140. As shown, the top cleat 146 has a top surface that is diamond grooved to provide an improved grip and includes two teeth configured to bite into the tree to add support and safety for the user at the desired height up the tree. As shown, the top cleat 146 is attached to the center post using a socket head bolt (e.g., ¼ inch) that passes longitudinally through the top cleat 146 and the center post 140. As shown, the rear side of the top cleat 146 has a cut-out portion that accommodates a nut (e.g., a nylon- or polymer-insert lock nut) to substantially prevent the nut from rotating as the socket head bolt is threaded into or out of the nut during assembly or disassembly, thereby eliminating the need for using a wrench during assembly or disassembly. As shown, a socket set screw (e.g., a ⅜ inch, 16 threads-per-inch (TPI) socket set screw) passes longitudinally through a vertical middle of the center portion 103 and has a rearward-facing adjustment knob 138 (e.g., a poly carbonate thumb nut) that allows the user to twist the set screw in and out to adjust the angle of the base plate 102 by pressing against the center post 140.

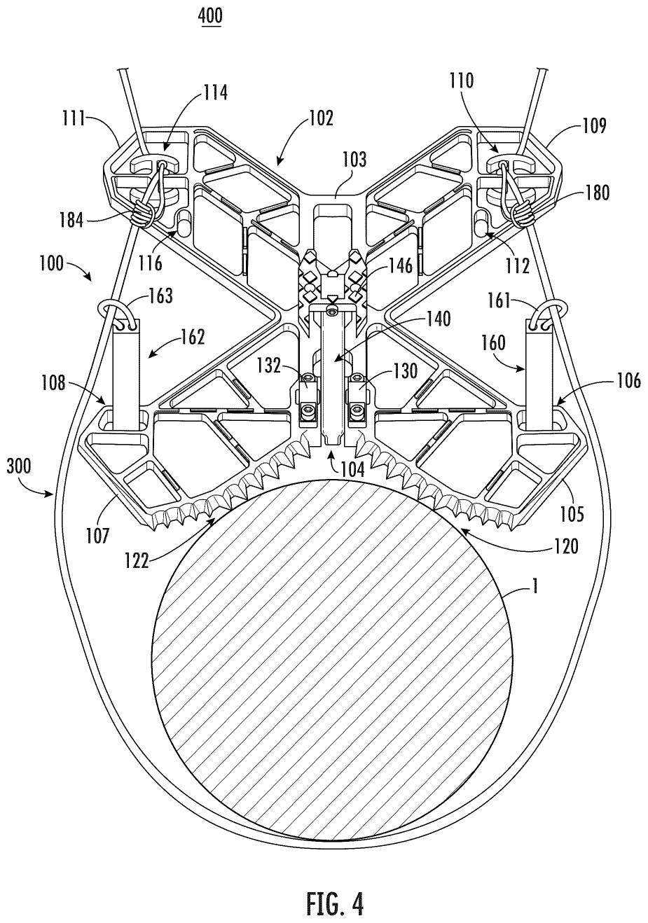

As shown, the first wing portion 105 of the base plate 102 includes a first lateral connection portion 106 disposed laterally spaced apart from the longitudinal axis Y on a first side (e.g., left side) of the longitudinal axis Y of the base plate 102 and forward of the lateral axis X of the base plate 102. As shown, the first arm guard 160 is configured to be removably connected to the base plate 102 by being press fit into the first lateral connection portion 106 of the base plate 102. Once attached, the first arm guard 160 is configured to stand vertically upright (e.g., to extend upward away from the base plate 102 in a vertically-oriented direction). In some aspects, the first arm guard 160 may be formed of a three-dimensional (3D)-printed polycarbonate material, a carbon fiber material, aluminum (e.g., milled or cast), or any other suitable material. As shown, the first arm guard 160 includes two vertically-oriented holes allowing a first arm guard rope 161 (shown in FIGS. 4-6) to run through the first arm guard 160 and girth hitch to the base plate 102 to form a first rope loop. The first arm guard rope 161 is part of the first arm guard 160 and can be formed of a thermoplastic resin material (e.g., ultra-high molecular weight polyethylene (UHMWPE)), an aramid fiber material (e.g., aromatic copolyimide fiber, para-aramid fiber), nylon, polyester (e.g., static polyester rope), or any other suitable material. The first arm guard rope 161 allows the tree cord to be encapsulated and maintain a proper angle for climbing and further allows the user to partially or fully remove the first arm guard 160 before, during, or after climbing so that the user may utilize the climbing stand assembly 100 as a saddle platform (e.g., a hunting platform) in addition to a climbing platform. As shown, the first wing portion 105 further includes teeth 120 (e.g., sharp rigid projections) disposed on a frontside surface configured to contact and grip the tree trunk.

As shown, the second wing portion 107 of the base plate 102 includes a second lateral connection portion 108 disposed laterally spaced apart from the longitudinal axis Y on a second side (e.g., right side) of the longitudinal axis Y of the base plate 102 and forward of the lateral axis X of the base plate 102. As shown, the second arm guard 162 is removably connected to the second lateral connection portion 108 of the base plate 102. As shown, the second arm guard 162 is configured to be removably connected to the base plate 102 by being press fit into the second lateral connection portion 108 of the base plate 102. Once attached, the second arm guard 162 is configured to stand vertically upright (e.g., to extend upward away from the base plate 102 in a vertically-oriented direction). In some aspects, the second arm guard 162 may be formed of a three-dimensional (3D)-printed polycarbonate material, a carbon fiber material, aluminum (e.g., milled or cast), or any other suitable material. As shown, the second arm guard 162 includes two vertically-oriented holes allowing a second arm guard rope 163 (shown in FIGS. 4-6) to run through the second arm guard 162 and girth hitch to the base plate 102 to form a second rope loop. The second arm guard rope 163 is part of the second arm guard 162 and can be formed of a thermoplastic resin material (e.g., UHMWPE), an aramid fiber material (e.g., aromatic copolyimide fiber, para-aramid fiber), nylon, polyester (e.g., static polyester rope), or any other suitable material. second arm guard rope 163 allows the tree cord to be encapsulated and maintain a proper angle for climbing and further allows the user to partially or fully remove the second arm guard 162 before, during, or after climbing so that the user may utilize the climbing stand assembly 100 as a saddle platform (e.g., a hunting platform) in addition to a climbing platform. As shown, the second wing portion 107 further includes teeth 122 (e.g., sharp rigid projections) disposed on a frontside surface configured to contact and grip the tree trunk.

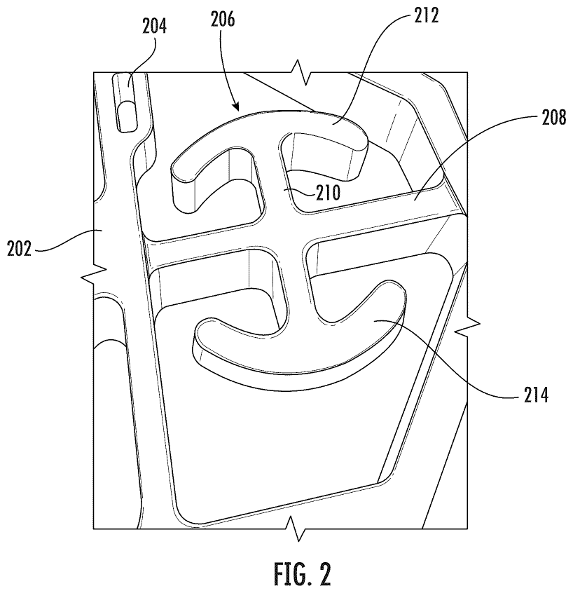

As shown, the third wing portion 109 of the base plate 102 includes a first tie-down anchor 110 and a first boot strap hole portion 112 that are formed integral to the base plate 102. As shown, the first tie-down anchor 110 is arranged in an “I” shape with serif portions (e.g., as described in greater detail with reference to FIG. 2) and is configured to provide a first anchor point for a tree cord as well as ropes or other rigging equipment. As shown, the first boot strap hole portion 112 is arranged as an oval-shaped hole positioned forward and inward of the first tie-down anchor 110 and is configured to provide a first opening for a boot strap to pass through and attach securely to the base plate 102.

As shown, the fourth wing portion 111 of the base plate 102 includes a second tie-down anchor 114 and a second boot strap hole portion 116 that are formed integral to the base plate 102. As shown, the second tie-down anchor 114 is arranged in an “I” shape with serif portions (e.g., as described in greater detail with reference to FIG. 2) and is configured to provide a second anchor point for the tree cord as well as ropes or other rigging equipment. As shown, the second boot strap hole portion 116 is arranged as an oval-shaped hole positioned forward and inward of the second tie-down anchor 114 and is configured to provide second opening for the boot strap to pass through and attach securely to the base plate 102.

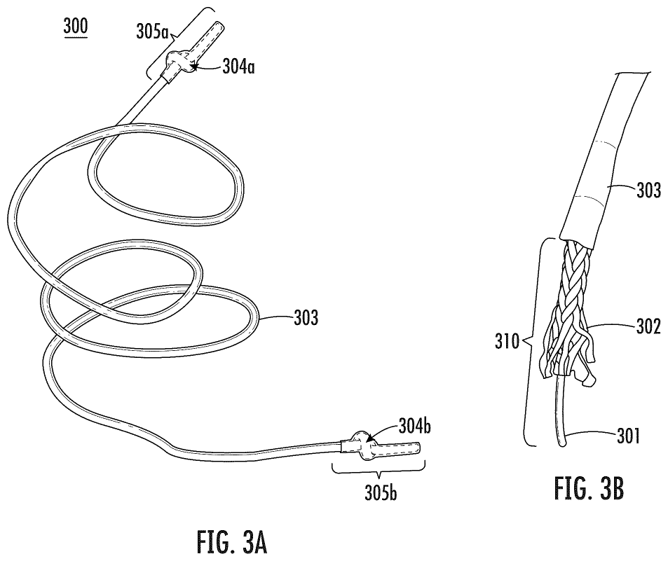

In some aspects, the tree cord may include a metallic core (e.g., a 9-gauge copper, steel, or aluminum wire surrounded by a UHMWPE braided fiber rope), a sheath (e.g., a protective nylon sheath), and shrink-wrapped knotted end regions (e.g., formed of a rubber heat shrink material or tubing placed over a knot tied in the end of the tree cord) to safeguard against knot displacement (e.g., as described in greater detail with reference to FIGS. 3A and 3B). In some aspects, a first portion of the tree cord may be tied to the first tie-down anchor 110, a second portion of the tree cord may be wrapped around the tree, and a third portion of the tree cord may be tied to the second tie-down anchor 114 (e.g., as described in greater detail with reference to FIGS. 3-6). In some aspects, the boot strap may be a 1-inch-wide nylon webbing having a male and female plastic buckle (e.g., a plastic buckle) on either end that is weaved through the first boot strap hole portion 112 and the second boot strap hole portion 116 to allow the user to clip their feet into the stand and pick their feet up with the stand as they climb the tree. In some aspects, one or more of the first tie-down anchor 110, the first boot strap hole portion 112, the second tie-down anchor 114, and the second boot strap hole portion 116 may have chamfered, beveled, and/or rounded edges to reduce the risk of cutting, fraying, or chaffing any ropes, cords, or straps attached thereto.

In some aspects, the climbing stand assembly 100 is configured to transform between multiple different states for storage, transportation, climbing, and standing (e.g., hunting). For example, as shown, the climbing stand assembly 100 is configured to transform between: (i) a first state for providing a storable platform having the center post 140 in the retracted position and the first arm guard 160 and the second arm guard 162 removed from the base plate 102; (ii) a second state for providing a climbing platform (e.g., for climbing up and down the tree) having the center post 140 in the extended position and the first arm guard 160 and the second arm guard 162 attached to the base plate 102, and (iii) a third state for providing a saddle platform (e.g., a hunting platform at the desired height up the tree) having the center post 140 in the extended position and the first arm guard 160 and the second arm guard 162 partially or fully removed from the base plate 102. As such, a user can use the climbing stand assembly 100 as a single-piece, combined climbing and saddle platform, eliminating the need for the user to carry a two-piece, separate climbing platform and saddle platform.

FIG. 2 is a close-up perspective view of a portion of an example base plate 202 having an integrally-formed boot strap hole portion 204 and an integrally-formed tie-down anchor 206 according to aspects of the disclosure. In some aspects, the boot strap hole portion 204 and the tie-down anchor 206 of the base plate 202 shown in FIG. 2 may correspond to: the first tie-down anchor 110 and the first boot strap hole portion 112 of the third wing portion 109 of the base plate 102; the second tie-down anchor 114 and the second boot strap hole portion 116 of the fourth wing portion 111 of the base plate 102; or a combination thereof.

In some aspects, the boot strap hole portion 204 and the tie-down anchor 206 may be integrally-formed with the base plate 202 by being milled (e.g., by a CNC machine) from the same piece of material (e.g., an aluminum plate) as the frame of the base plate 202. As shown, the edges of the boot strap hole portion 204 and the tie-down anchor 206 are chamfered to substantially prevent them from cutting, fraying, or chaffing any ropes, cords, straps, or rigging attached thereto. Additionally, or alternatively, the edges of the boot strap hole portion 204 and the tie-down anchor 206 may be beveled or rounded.

As shown, the first boot strap hole portion 204 is arranged as an oval-shaped hole configured to provide an opening for a boot strap to pass through and attach securely to the base plate 202. As shown, the tie-down anchor 206 is arranged in an “I” shape with serif portions. As shown, the tie-down anchor includes a cross-bar 208 that is integrally attached at both ends to the frame of the base plate 202. As shown, the tie-down anchor 206 further includes a beam 210 disposed substantially orthogonal to the cross-bar 208 and integrally attached to the cross-bar 208 at about the center of the cross-bar 208. As shown, the tie-down anchor 206 further includes a first serif portion 212 integrally attached to a first end portion of the beam 210. As shown, the tie-down anchor 206 further includes a second serif portion 214 integrally attached to a second end portion of the beam 210 disposed opposite the first end portion of the beam 210. As shown, each end region of the first serif portion 212 and the second serif portion 214 is curved inwardly toward the cross-bar 208 to form a “C” shaped hook that provides a protective guard against rope slippage, resulting in improved anchoring for ropes, cords, and rigging attached to the tie-down anchor 206.

In some aspects, as shown, the tie-down anchor 206 has a recessed vertical profile in relation to the frame of the base plate 202. For example, as shown, the top and bottom surfaces of the cross-bar 208, the beam 210, the first serif portion 212, and the second serif portion 214 are recessed from the top and bottom surfaces of the frame of the base plate 202, as most clearly shown at the integral formation regions between the ends of the cross-bar 208 and the frame of the base plate 202. As a result, the height of any ropes, cords, prusiks, and other rigging attached to the tie-down anchor 206 will be decreased relative to the top surface of the frame of the base plate 202, making them less cumbersome to the user (e.g., by providing a reduced tripping hazard for the user) and less prone to damage (e.g., by the user stepping on them and grinding dirt and debris into the fibers, which can substantially reduce strength and lifespan over time).

In some aspects, the use of tie-down anchors such as tie-down anchor 206 eliminates the need for pins or buckles to be used to secure the prusik tails of the rigging (e.g., an improvement over conventional tree stands), allowing the user to tie into or girth hitch into the climbing stand assembly. For example, by taking the tail of a prusik going around one side of the tie-down anchor 206 and back up through the other side of the tie-down anchor 206, the user can lock down the prusik tail. Other climbing platforms utilize pins or buckles to secure their attachment.

FIGS. 3A and 3B are perspective and cut-away views of an example tree cord 300 according to aspects of the disclosure. In some aspects, the tree cord 300 is configured to wrap around a tree and be removably connected to at least two tie-down anchors, a first arm guard, and a second arm guard of a climbing stand assembly (e.g., climbing stand assembly 100).

As shown, the tree cord 300 includes a metallic core 310, a sheath 303 surrounding the metallic core 310, and shrink-wrapped knotted end regions 305a and 305b. In some aspects, the metallic core 310 of the tree cord 300 includes a metal wire 301 (e.g., a 9-gauge copper, steel, or aluminum wire) disposed longitudinally within a braided fiber rope 302. In some aspects, the braided fiber rope 302 can be formed of UHMWPE fibers or any other suitable material and, optionally, may be coated with an abrasion-resistant material. In some aspects, the sheath 303 of the tree cord 300 may be a chafe sleeve that consists essentially of nylon or any other suitable material. In some aspects, as shown, a knot 304a, 304b is tied at each end of the tree cord 300, and shrink wrap is placed over these knots 304a, 304b, forming the shrink-wrapped knotted end regions 305a, 305b, to substantially prevent the knots 304a, 304b from coming undone. As such, the first shrink-wrapped knotted end region 305a of the tree cord 300 includes a first knot 304a and a first rubber heat shrink material or tubing covering the first knot 304a, and the second shrink-wrapped knotted end region 305b of the tree cord 300 includes a second knot 304b and a second rubber heat shrink material or tubing covering the second knot 304b.

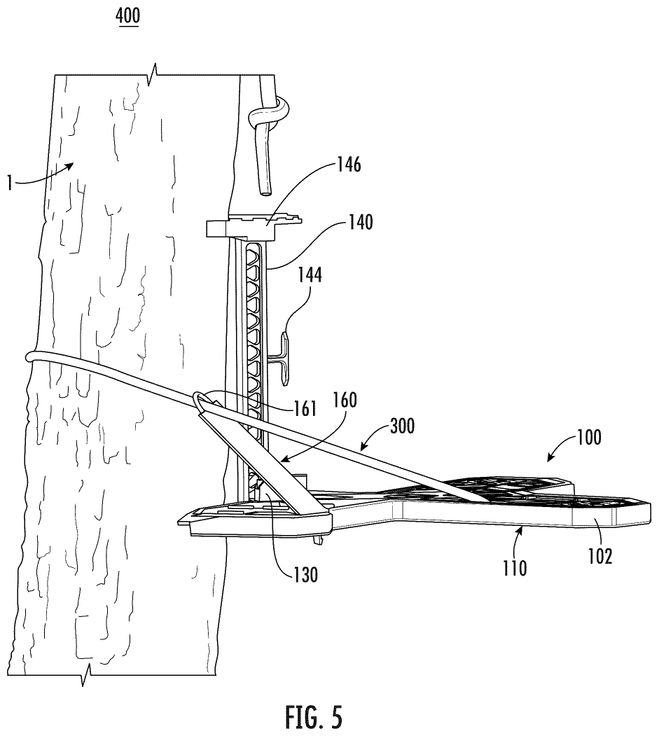

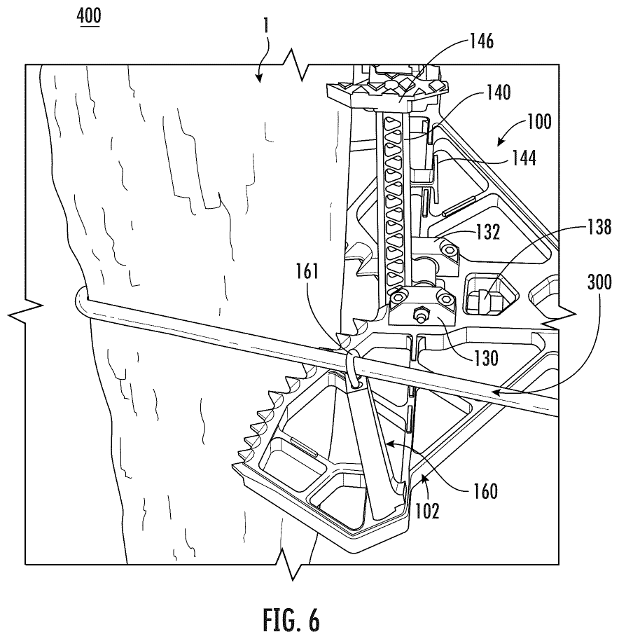

FIG. 4 is a top view of an example climbing stand system 400 for climbing a tree 1 according to aspects of the disclosure. As shown, the climbing stand system 400 includes the climbing stand assembly 100 (described with reference to FIGS. 1-2) gripping the tree 1 and the tree cord 300 (described with reference to FIG. 3) wrapped around the tree 1 and attached to the climbing stand assembly 100. FIG. 5 is a side view of the example climbing stand system 400 shown in FIG. 4 according to aspects of the disclosure. FIG. 6 is a perspective view of the example climbing stand system 400 shown in FIG. 4 according to aspects of the disclosure.

In some aspects, the tree cord 300 is substantially rigid yet moldable, allowing the user to adjust the tree cord 300 to the appropriate angle. In some aspects, as shown in FIGS. 4-6, two prusiks (180, 184) may be used to attach the two ends of the tree cord 300 to a base plate of a climbing stand assembly. The tail end of each prusik (180, 184) may be attached to a respective one of the two tie-down anchors (110, 114), and the tree cord 300 may be press fit into the corner of the respective tie-down anchor (110, 114). The tree cord 300 may run through the rope loops (161, 163) of the two arm guards (160, 162), which help guide the tree cord 300 at the appropriate angle around the tree 1.

In one illustrative example, the user may press fit the shrink-wrapped knotted end region 305a of the tree cord 300 into the inside corner of the first tie-down anchor 110 and guide the shrink-wrapped knotted end region 305b of the tree cord 300 through the top of the first tie-down anchor 110. The user then may guide the shrink-wrapped knotted end region 305b of the tree cord 300 through the first rope loop formed by the first arm guard rope 161 at the top of the first arm guard 160, around the tree, and back through the second rope loop formed by the second arm guard rope 163 of the second arm guard 162. The user then may press fit the shrink-wrapped knotted end region 305b of the tree cord 300 into the inside corner of the second tie-down anchor 114 to securely fasten the tree cord 300 to the base plate 102 of the climbing stand assembly 100. The user then may form a respective prusik 180, 184 around each side of the tree cord 300 using a continuous rope loop (e.g., made of UHMWPE or another suitable material) and secure each prusik tail to the respective tie-down anchor 110, 114. The user then may slide a castration band down on each prusik tail to secure each prusik 180, 184 to the respective tie down anchor 110, 114.

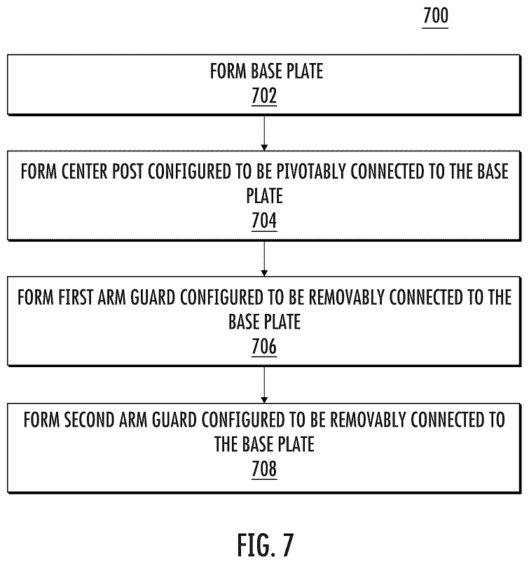

FIG. 7 is a flow chart of an example method 700 for manufacturing a climbing stand assembly according to aspects of the disclosure. In some aspects, the steps disclosed with respect to example method 700 provide improved (e.g., simpler, easier, more secure) techniques for climbing stand assembly constructions that provide both climbing platform and saddle platform functionalities. It is noted that one or more steps may be combined, that certain steps may be omitted, and that the steps may be performed in any preferred order as desired.

At step 702, the method 700 includes forming a base plate (e.g., base plate 102, 202) comprising a center connection portion, a first lateral connection portion disposed on a first side of the of the base plate, a second lateral connection portion disposed on a second side of the base plate opposite the first side of the base plate, at least two tie-down anchors, and at least two boot strap hole portions (e.g., as described with reference to FIGS. 1-6). At step 704, the method 700 includes forming a center post (e.g., center post 140) configured to be pivotably connected to the center connection portion of the base plate (e.g., as described with reference to FIGS. 1-6). At step 706, the method 700 includes forming a first arm guard (e.g., first arm guard 160) configured to be removably connected to the first lateral connection portion of the base plate (e.g., as described with reference to FIGS. 1-6). At step 708, the method 700 includes forming a second arm guard (e.g., second arm guard 162) configured to be removably connected to the second lateral connection portion of the base plate (e.g., as described with reference to FIGS. 1-6).

It will be appreciated by those skilled in the art that changes may be made to the example climbing stand systems, assemblies, and tree cords described above with reference to FIGS. 1-7 without departing from the scope of the present disclosure. For example, it is contemplated that other climbing stand and tree cord constructions can be made in accordance with this disclosure by combining, omitting, or modifying aspects of the aspects described herein. Additionally, it is to be understood that the steps of the example method set forth herein are not necessarily required to be performed in the order described, and the order of such steps is to be understood to be merely an example ordering. Likewise, additional steps may be included, and certain steps may be combined, omitted, or modified in accordance with the aspects of the present disclosure. As such, it will be appreciated that the scope of the disclosure and the accompanying claims and their equivalents covers both the particular aspects disclosed herein as well as modifications thereof.

Unless explicitly stated otherwise, each numerical value and range are to be interpreted as being approximate, as if the word “about,” “approximately,” or “substantially” preceded the value or range, and is intended to include the degree of error associated with measurement of the particular quantity based upon the equipment available at the time of filing the application. Accordingly, unless indicated to the contrary, the numerical parameters, grades, and gauges set forth herein are approximations that may vary depending upon the desired properties sought to be obtained by the present disclosure.

It will be understood that reference herein to “a” or “one” to describe a feature such as a component, structure, or step does not foreclose additional features or multiples of the feature. For instance, reference to a climbing stand assembly or tree cord having, comprising, including, or defining “one” of a feature does not preclude the climbing stand assembly or tree cord from having, comprising, including, or defining more than one of the feature, as long as the climbing stand assembly or tree cord has, comprises, includes, or defines at least one of the feature. Similarly, reference herein to “one of” a plurality of features does not foreclose the climbing stand assembly or tree cord from including two or more of the features.

What is claimed is:

1. A climbing stand assembly comprising:
a base plate comprising
a center connection portion,
a first lateral connection portion disposed on a first side of the of the base plate, and
a second lateral connection portion disposed on a second side of the base plate opposite the first side of the base plate;
a center post configured to be pivotably connected to the center connection portion of the base plate, wherein the center post is pivotable between a retracted position that is substantially parallel to a longitudinal axis of the base plate and an extended position that is non-parallel to the longitudinal axis of the base plate;
a first arm guard configured to be removably connected to the first lateral connection portion of the base plate; and
a second arm guard configured to be removably connected to the second lateral connection portion of the base plate.

2. The climbing stand assembly of claim 1, wherein the climbing stand assembly is configured to transform between
a storable platform having the center post in the retracted position and the first arm guard and the second arm guard removed from the base plate,
a climbing platform having the center post in the extended position and the first arm guard and the second arm guard connected to the base plate, and
a saddle platform having the center post in the extended position and the first arm guard and the second arm guard removed from the base plate.

3. The climbing stand assembly of claim 1, wherein the center connection portion of the base plate comprises at least one pivot block attached to the base plate, wherein the center post is pivotably connected to the at least one pivot block.

4. The climbing stand assembly of claim 1, wherein the center post further comprises a versa button having at least one chamfered edge.

5. The climbing stand assembly of claim 1, wherein the center post further comprises a top cleat having a top surface that is diamond grooved.

6. The climbing stand assembly of claim 1, wherein
the first arm guard is configured to be removably connected to the first lateral connection portion of the base plate by being press fit into the first lateral connection portion of the base plate, and
the second arm guard is configured to be removably connected to the second lateral connection portion of the base plate by being press fit into the second lateral connection portion of the base plate.

7. The climbing stand assembly of claim 1, wherein, when connected to the base plate, each of the first arm guard and the second arm guard is configured to extend away from the base plate in a vertical direction.

8. The climbing stand assembly of claim 1, wherein the base plate further comprises at least two integral tie-down anchors.

9. The climbing stand assembly of claim 8, wherein each of the at least two integral tie-down anchors includes at least one serif portion and at least one chamfered edge.

10. The climbing stand assembly of claim 1, wherein the base plate comprises a metal material, a metal alloy material, or a composite material.

11. The climbing stand assembly of claim 10, wherein the base plate consists essentially of aluminum, aluminum alloy, or carbon fiber.

12. The climbing stand assembly of claim 1, wherein the center post comprises a metal material, a metal alloy material, or a composite material.

13. The climbing stand assembly of claim 12, wherein the center post consists essentially of aluminum, aluminum alloy, or carbon fiber.

14. The climbing stand assembly of claim 1, wherein each of the first arm guard and the second arm guard comprises a polycarbonate material.

15. A climbing stand system comprising:
a climbing stand assembly comprising a base plate, a center post configured to be pivotably connected to a center connection portion of the base plate, a first arm guard configured to be removably connected to a first lateral connection portion of the base plate, a second arm guard configured to be removably connected to a second lateral connection portion of the base plate, and at least two tie-down anchors formed integrally with the base plate; and
a tree cord configured to be removably connected to the at least two tie-down anchors, the first arm guard, and the second arm guard, the tree cord comprising a metallic core, a sheath surrounding the metallic core, and shrink-wrapped knotted end regions.

16. The climbing stand system of claim 15, further comprising:
at least two boot strap hole portions formed integrally with the base plate; and
a boot strap configured to be removably connected to the at least two boot strap hole portions.

17. The climbing stand system of claim 15, wherein the metallic core of the tree cord comprises a metal wire disposed longitudinally within a braided fiber rope.

18. The climbing stand system of claim 15, wherein the sheath of the tree cord consists essentially of nylon.

19. The climbing stand system of claim 15, wherein the shrink-wrapped knotted end regions of the tree cord comprise a rubber heat shrink material.

20. A method for manufacturing a climbing stand assembly, the method comprising:
forming a base plate comprising
a center connection portion,
a first lateral connection portion disposed on a first side of the of the base plate,
a second lateral connection portion disposed on a second side of the base plate opposite the first side of the base plate,
at least two tie-down anchors, and
at least two boot strap hole portions;
forming a center post configured to be pivotably connected to the center connection portion of the base plate;
forming a first arm guard configured to be removably connected to the first lateral connection portion of the base plate; and
forming a second arm guard configured to be removably connected to the second lateral connection portion of the base plate.
